(19) United States
(12) Patent Application Publication
(10) Pub. No.: US 2026/0259378 A1
(43) Pub. Date: Sep. 3, 2026

(54) OPTICAL BEAM DELIVERY SYSTEM INCLUDING MICRO-OPTICAL BENCH MOUNTED WITHIN VACUUM CHAMBER FOR DIRECT BEAM DELIVERY

(71) Applicant: Quantinuum LLC, Broomfield, CO (US)

(72) Inventors: Adam Jay OLLANIK, Boulder, CO (US); David M. GAUDIOSI, Loveland, CO (US); Loren W. JONES, Broomfield, CO (US)

(21) Appl. No.: 19/533,559

(22) Filed: Feb. 9, 2026

Related U.S. Application Data
(60) Provisional application No. 63/764,812, filed on Feb. 28, 2025.

(51) Int. Cl. G02B 6/36

(52) U.S. Cl. CPC G02B 6/3648

(57) ABSTRACT

An optical beam delivery system is provided. The optical beam delivery system includes one or more micro-optical benches (MOBs). Each MOB of the one or more MOBs includes a substrate, and a plurality of signal manipulation elements. Each signal manipulation element of the plurality of signal manipulation elements is disposed on or in the substrate. The plurality of signal manipulation elements are configured to provide an array of optical beams directly to an array of target locations. For example, the optical beams propagate through free space from the signal manipulation elements to the respective target locations without interacting with any additional optical elements, in various embodiments.

### CROSS-REFERENCE TO RELATED APPLICATION(S)

This application claims priority to U.S. Application No. 63/764,812, filed Feb. 28, 2025, the content of which is incorporated herein by reference in its entirety.

### TECHNICAL FIELD

Various embodiments relate to an optical beam delivery system. Various embodiments relate to an optical beam delivery system mounted within a vacuum chamber and configured to provide optical beams directly to an array of target locations for atomic and/or quantum object interaction, for example.

### BACKGROUND

In various systems, it is desired to provide an array of optical beams to an array of target locations. For example, in atomic and/or quantum systems, the optical beams may be used to interact with atomic and/or quantum objects confined at the target locations that are disposed within a vacuum chamber and/or cryostat. Conventionally, the optical beams are provided via an optical beam delivery system located outside of the vacuum chamber and/or cryostat using global relay optics. However, in such an approach, the global relay optics are required to be designed for use with a broad range of optical wavelengths (e.g., infrared (IR) through ultraviolet (UV)). Through applied effort, ingenuity, and innovation many deficiencies of such prior optical beam delivery systems have been solved by developing solutions that are structured in accordance with the embodiments of the present invention, many examples of which are described in detail herein.

### BRIEF SUMMARY OF SOME EXAMPLE EMBODIMENTS

Various embodiments provide optical beam delivery systems where the optical beam delivery system is configured for mounting within a cryogenic and/or vacuum chamber. For example, in various embodiments, the optical beam delivery systems are configured to provide an array of optical beams to an array of target locations (e.g., defined by an atomic and/or quantum object confinement apparatus) without the use of global relay optics. In various embodiments, the optical beam delivery system comprise one or more micro-optical benches (MOBs) that each include a substrate comprising a plurality of signal manipulation elements. The MOBs are configured to provide the optical beams directly to the target locations. For example, no relay optics are disposed between the signal manipulation elements of the MOB and the target location. Various embodiments provide atomic and/or quantum systems comprising an optical beam delivery system of an example embodiment.

According to one aspect, an optical beam delivery system is provided. In an example embodiment, the optical beam delivery system includes one or more micro-optical benches (MOBs). Each MOB of the one or more MOBs includes a substrate, and a plurality of signal manipulation elements. Each signal manipulation element of the plurality of signal manipulation elements is disposed on or in the substrate. The plurality of signal manipulation elements are configured to provide an array of optical beams directly to an array of target locations.

In an example embodiment, each signal manipulation element of the plurality of signal manipulation elements is a non-global optical element.

In an example embodiment, each signal manipulation element of the plurality of signal manipulation elements is a respective one of a lens, a metasurface, a diffractive optical element, a grating, a waveplate, or a refractive optical element.

In an example embodiment, the optical beam delivery system is configured for use at a working temperature and the working temperature is 100K or less.

In an example embodiment, the optical beam delivery system is configured such that provision of optical beams to the optical beam delivery system when the one or more MOBs are at a non-cryogenic temperature, results in providing the array of optical beams that is characterized by a different spacing than the array of target locations.

In an example embodiment, the MOB is configured to be disposed within 10 centimeters of the array of target locations.

In an example embodiment, each MOB of the one or more MOBs further comprises one or more waveguides formed in the substrate.

In an example embodiment, the one or more waveguides and the plurality of signal manipulation elements define a plurality of beam paths with each beam path of the plurality of beam paths configured for providing optical beams characterized by a respective wavelength to a respective target location of the array of target locations.

In an example embodiment, the substrate further comprises one or more optical fiber coupling components, each of the one or more optical fiber coupling components configured for mechanically coupling an optical fiber to the substrate and to optically couple the optical fiber to one or more beam paths of the plurality of beam paths.

In an example embodiment, the one or more beam paths form sets of branched beam paths where the beam paths of a set of branched beam paths are connected to one another via one or more beam splitters.

In an example embodiment, at least one beam path of the one or more beam paths comprises a modulator configured to control, at least in part, whether an optical beam is provided to the respective target location via the beam path when an optical beam is provided to the one or more beam paths.

In an example embodiment, each optical fiber of the one or more optical fibers provides optical beams having a respective common characteristic wavelength.

In an example embodiment, each beam path of the plurality of beam paths comprises a respective one or more signal manipulation elements of the plurality of signal manipulation elements and the respective one or more signal manipulation elements of a beam path are configured to control one or more optical properties of an optical beam provided to a corresponding target location via the beam path.

In an example embodiment, the optical beam delivery system includes an array of optical fibers coupled to the one or more MOBs and configured to provide optical beams to the one or more MOBs.

According to another aspect, an atomic or quantum system is provided. In an example embodiment, the atomic or quantum system includes a vacuum chamber; an atomic or quantum object confinement apparatus disposed within the vacuum chamber and defining an array of target locations; and an optical beam delivery system. The optical beam delivery system includes one or more micro-optical benches (MOBs). Each MOB of the one or more MOBs includes a substrate, and a plurality of signal manipulation elements. Each signal manipulation element of the plurality of signal manipulation elements is disposed on or in the substrate. The plurality of signal manipulation elements are configured to provide an array of optical beams directly to the array of target locations. The one or more MOBs are disposed within the vacuum chamber.

In an example embodiment, the atomic or quantum system further includes one or more lasers coupled to the one or more MOBs via respective optical fibers such that the one or more lasers are configured to provide optical beams to the one or more MOBs via the respective optical fibers and the one or more lasers disposed outside of the vacuum chamber.

In an example embodiment, a MOB of the one or more MOBs is mounted to at least one of an interior surface of the vacuum chamber, a pedestal configured to host the atomic or quantum object confinement apparatus, or the atomic or quantum object confinement apparatus.

In an example embodiment, a MOB of the one or more MOBs is mounted within the vacuum chamber via a dynamic stage comprising nano-positioners.

In an example embodiment, the vacuum chamber is a cryogenic chamber and the optical beam delivery system is configured for use at a working temperature and the working temperature is 100K or less.

In an example embodiment, the MOB is configured to be disposed within 10 centimeters of the array of target locations.

In an example embodiment, the system is a QCCD-based quantum computer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a schematic diagram of an example atomic and/or quantum system including an optical beam delivery system, in accordance with an example embodiment.

FIGS. 2A, 2B, and 2C provide schematic cross-sectional views of example MOBs providing optical beams directly to target locations, according to some example embodiments.

FIG. 3 provides a schematic cross-sectional view of an example MOB including branched beam paths, according to an example embodiment.

FIGS. 4A and 4B provide a schematic diagrams of MOBs mounted to a pedestal hosting the atomic and/or quantum object confinement apparatus, according to some example embodiments.

FIG. 5 provides a schematic diagram of an example controller of an atomic and/or quantum system that may be used in accordance with an example embodiment.

FIG. 6 provides a schematic diagram of an example computing entity that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits and/or within user measurement capabilities, unless otherwise indicated. Like numbers refer to like elements throughout.

In various systems, it is desired to provide an array of optical beams to an array of target locations. For example, in atomic and/or quantum systems, the optical beams may be used to interact with atomic and/or quantum objects confined at the target locations that are disposed within a vacuum chamber and/or cryostat. Conventionally, the optical beams are provided via an optical beam delivery system located outside of the vacuum chamber and/or cryostat using global relay optics. However, in such an approach, the global relay optics are required to be designed for use with a broad range of optical wavelengths (e.g., infrared (IR) through ultraviolet (UV)). As a result, the global relay optics may not be able to efficiently provide at least a subset of the optical beams. Additionally, when the MOB is far from the array of target locations, the arrayed optical beams overlap and individual target locations may no longer be addressed individually. Therefore technical problems exist regarding providing an array of optical beams to an array of target locations, especially when the array of target locations are located within a cryogenic and/or vacuum chamber.

Various embodiments provide technical solutions to these technical problems. In various embodiments, an optical beam delivery system is provided that includes one or more micro-optical benches (MOBs) configured to be mounted within a cryogenic and/or vacuum chamber that houses an atomic and/or quantum object confinement apparatus. The atomic and/or quantum object confinement apparatus defines a plurality of target locations. In various embodiments, the plurality of target locations are arranged in a one-dimensional or two-dimensional periodic array of target locations. Mounting the MOBs within the cryogenic and/or vacuum chamber enables the MOBs to be within 10 centimeters of the target locations. Thus, no global relay optics are required. In other words, the MOBs provide the optical beams directly to the target locations. As used herein providing an optical beam directly to a target location via a MOB means that there are no optical elements between the point where the optical beam exits the MOB and the target location. For example, between the MOB and the target location, an optical beam may propagate (only) through free space (e.g., through (only) vacuum since the MOB and the target location are located within a cryogenic and/or vacuum chamber). As a result, no global relay optics are required. For example, each beam path of the optical beam delivery system may be designed, configured, and/or optimized for providing optical beams of a particular characteristic wavelength. This enables the system to provide optical beams more efficiently such that less optical power is lost as the optical beams are provided to the plurality of target locations. Additionally, as optical beams are provided by MOBs no more than 10 centimeters from the respective target locations, the array of optical beams may be configured to not spatially overlap such that individual target locations may be addressed individually (e.g., independently of other target locations). Therefore, various embodiments provide technical improvements and/or advantages to the fields of optical beam delivery, optical beam delivery of an array of optical beams characterized by various wavelengths across the optical spectrum (e.g., IR to UV), and/or optical beam delivery to target locations of atomic and/or quantum systems disposed within a cryogenic and/or vacuum chamber.

### Example Atomic and/or Quantum System

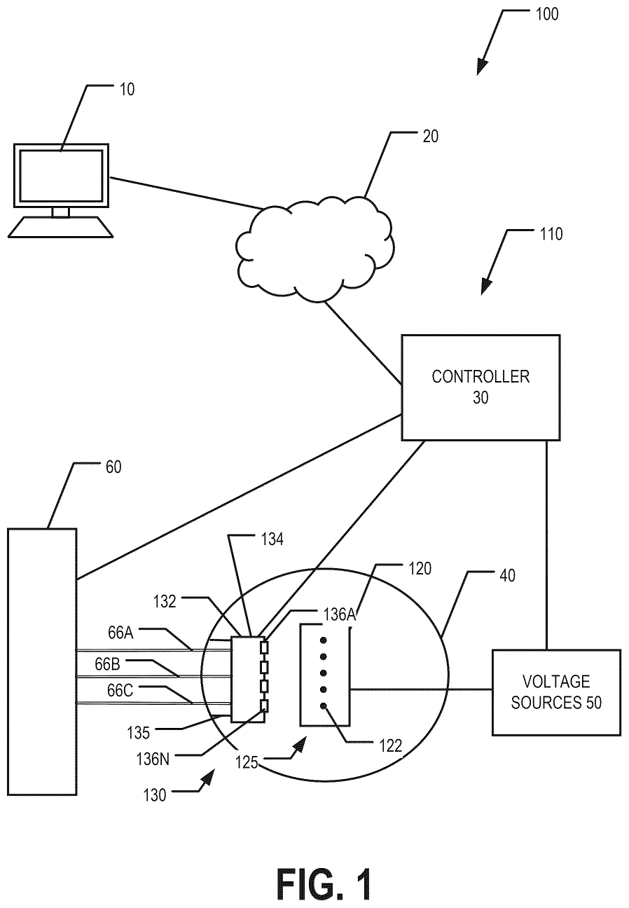

In various embodiments, an optical beam delivery system configured to deliver a plurality of optical beams to a plurality of target locations defined by an atomic and/or quantum confinement apparatus is provided. For example, the optical beam delivery system may be configured to provide an array of optical beams to a one-dimensional or two-dimensional array of target locations defined by an atomic and/or quantum confinement apparatus. FIG. 1 provides a schematic diagram of an example atomic and/or quantum system that is a QCCD-based quantum computer system 100, in accordance with an example embodiment. In some embodiments, a quantum computer system 100 includes an optical beam delivery system 130 that includes at least one micro-optical bench (MOB) 132. The at least one MOB 132 is configured to provide optical beams directly to target locations 122. In various embodiments, the one or more target locations 122 are arranged in a one-dimensional or two-dimensional array of target locations 125.

In various embodiments, the quantum computer system 100 comprises a computing entity 10 and a quantum computer 110. In various embodiments, a controller 30 of the quantum computer 110 may be in communication with the computing entity 10 via one or more wired and/or wireless networks 20. In various embodiments, the quantum computer 110 comprises the controller 30, a cryogenic and/or vacuum chamber 40 enclosing a confinement apparatus 120 (e.g., an ion trap, surface ion trap, Paul trap, optical trap, and/or the like), one or more manipulation sources 60 (e.g., one or more laser systems), one or more optical fibers 66 (e.g., 66A, 66B, 66C) configured to deliver manipulation signals (e.g., optical beams such as laser beams) generated by the manipulation sources 60 (e.g., lasers) to target locations 122 defined at least in part by the confinement apparatus 120, and/or the like. In various embodiments, the confinement apparatus 120 is a confinement apparatus configured to confine one or more atomic and/or quantum objects such as atoms, ions, molecules, quantum particles, and/or the like therein and the manipulation sources 60 are configured to provide manipulation signals (e.g., optical beams such as laser beams) to one or more target locations defined at least in part by the confinement apparatus 120 via optical paths defined at least in part by the optical beam delivery system 130. In various embodiments, the optical beam delivery system 130 comprises optical fibers 66 configured to provide optical beams (e.g., laser beams) generated by manipulation sources 60 (e.g., lasers) to one or more micro-optical benches (MOBs) 132 disposed within the cryogenic and/or vacuum chamber 40. The optical beam delivery system 130 further comprises the one or more MOBs 132, which each include a substrate 134 and a plurality of signal manipulation elements 136 (e.g., 136A-136N).

In various embodiments, the manipulation signals may be used to initialize one or more atomic and/or quantum objects (e.g., atoms, ions, molecules, quantum particles, and/or the like) into a qubit space, perform cooling operations, perform measurement operations, provide one or more gate signals, and/or the like. In various embodiments, the manipulation sources 60 comprise one or more laser systems configured to provide one or more manipulation signals (e.g., laser and/or optical beams and/or pulses) to one or more target locations 122 defined at least in part by the confinement apparatus 120 to enact one or more quantum gates (e.g., quantum logic gates) or other quantum operations. In various embodiments, the quantum gates may be single qubit gates, two-qubit gates, and/or the like. In various embodiments, one or more gate signals may be provided to the one or more target locations 122 defined at least in part by the confinement apparatus 120 via beam delivery system(s) 130, which may include one or more MOBs 132.

In various embodiments, a computing entity 10 is configured to allow a user to provide input to the quantum computer system 100 (e.g., via a user interface of the computing entity 10) and receive, view, and/or the like output from the quantum computer system 100. The computing entity 10 may be in communication with the controller 30 via one or more wired or wireless networks 20. For example, the computing entity 10 may be configured to provide quantum circuits to the controller 30 for execution by the quantum computer 110 and the controller 30 may provide the results of executing one or more quantum circuits to the computing entity 10.

In various embodiments, the controller 30 is configured to control the confinement apparatus 120, cooling and/or vacuum systems (not shown) controlling the temperature and pressure within the cryogenic and/or vacuum chamber 40, manipulation sources 60, and/or other components of the quantum computer 110 (e.g., an optical collection system configured for “reading” the output of the quantum computer). In various embodiments, the controller 30 is configured to control operation of the confinement apparatus 120 by controlling operation of one or more voltage sources 50 such that the voltage sources 50 provide voltage signals to potential generating elements (e.g., electrodes) of the confinement apparatus 120 to cause the generation of one or more trapping and/or confinement potentials configured for trapping and/or confining atomic and/or quantum objects. For example, the voltage sources 50 may include one or more arbitrary wave generators (AWGs), digital to analog converters (DACs), and/or the like.

In various embodiments, the controller 30 is configured to control various components of the quantum computer 110 in accordance with executable instructions, command sets, and/or the like provided by the computing entity 10 and/or generated by the controller 30. In various embodiments, the controller 30 is configured to receive output from the quantum computer 110 (e.g., from an optical collection system) and provide the output and/or the result of processing the output to the computing entity 10.

### Example Optical Beam Delivery System

In various embodiments, an optical beam delivery system 130 comprises one or more micro-optical benches (MOBs) 132. Each MOB 132 is in optical communication with one or more manipulation sources 60 (e.g., lasers) via one or more optical fibers 66. In various embodiments, the MOB(s) 132 are disposed within a cryogenic and/or vacuum chamber 40 and the one or more manipulation sources 60 are disposed outside of the cryogenic and/or vacuum chamber 40. In various embodiments, the MOB(s) 132 of the optical beam delivery system 130 comprise a plurality of signal manipulation elements 136 (e.g., 136A-136N). The plurality of signal manipulation elements 136 is configured to provide an array of optical beams to an array of target locations 125. In some embodiments, the array of target locations 125 are defined, at least in part, by an atomic and/or quantum object confinement apparatus 120 disposed within the cryogenic and/or vacuum chamber 40. For example, the atomic and/or quantum object confinement apparatus 120 may be configured to confine atomic and/or quantum objects at respective target locations 122 of the array of target locations 125 and the array of optical beams may be provided to the array of target locations 125 for interacting with the atomic and/or quantum objects confined at the respective target locations 122.

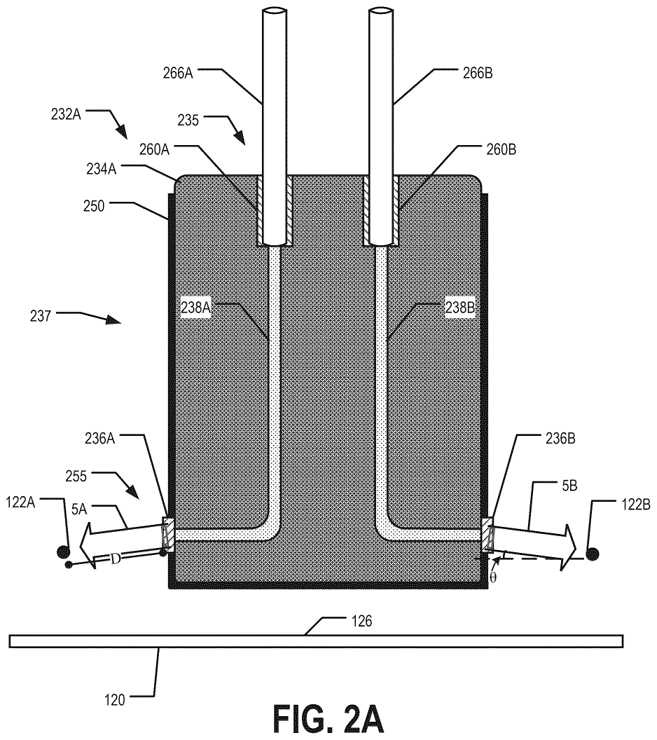

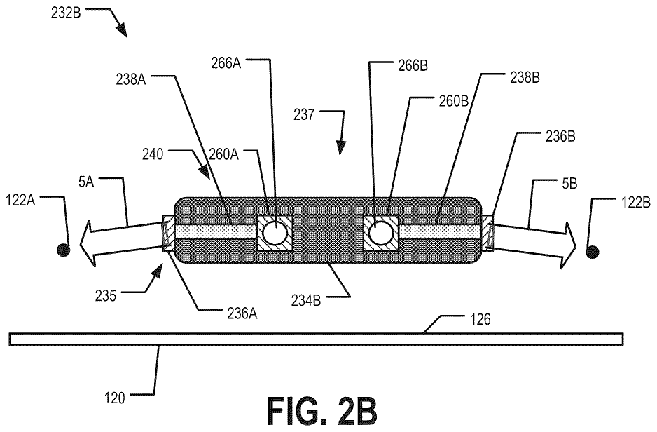

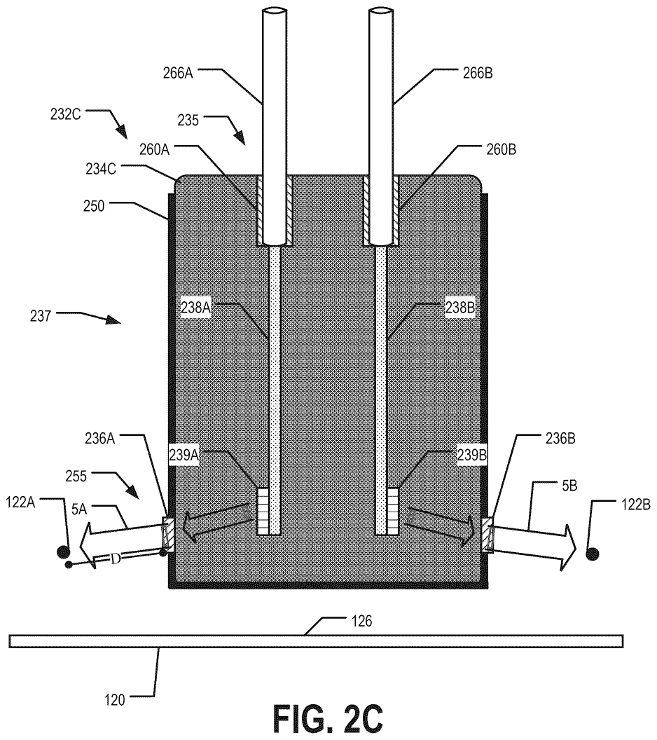

FIGS. 2A, 2B, and 2C illustrate cross-sectional views of example MOBs 232A, 232B, 232C where the cross-section is taken in a plane that is normal to the surface 126 of the atomic and/or quantum object confinement apparatus 120. The MOB 232A is configured to provide optical beams via sides or faces of the substrate 234A of the MOB 232A and the MOB 232B is configured to provide optical beams via facets of the substrate 234B of the MOB 232B.

In various embodiments, a MOB 232 (e.g., 232A, 232B, 232C) includes a substrate 234 (e.g., 234A, 234B, 234C). In certain embodiments, the substrate 234 is formed of and/or comprises a material that is generally transparent to light of the optical spectrum (e.g., IR to UV). For example, the substrate 234 may be formed of and/or comprise glass. In various embodiments, the substrate 234 hosts a plurality of signal manipulation elements 236 (e.g., 236A, 236B) fabricated and/or secured on and/or in the substrate 234. In various embodiments, the substrate 234 comprises a plurality of waveguides 238 (e.g., 238A, 238B) and one or more optical fiber coupling components 260 (e.g., 260A, 260B).

For example, the plurality of waveguides 238 may provide and/or define beam paths from respective optical fiber coupling components 260 to respective signal manipulation elements 236 such that optical beams provided to the MOB 232 via respective optical fibers 266 (e.g., 266A, 266B) coupled to respective optical fiber coupling components 260 may be provided to respective signal manipulation elements 236. The respective signal manipulation elements 236 may then provide the optical beams to respective target locations 122 of the array of target locations 125. In various embodiments, an optical fiber 266 is configured to provide optical beams having a respective common characteristic wavelength. In other words, each optical beam provided by an optical fiber 266 is characterized by the same respective wavelength. However, different optical fibers, such as the optical fiber 266A and the optical fiber 266B may provide optical beams characterized by different wavelengths from one another.

In various embodiments, the signal manipulation elements 236 may be fabricated on, secured to, and/or configured to provide optical beams via one or more sides or faces 237 of the substrate 234 or via one or more facets 235 of the substrate 234. For example, in some embodiments, a MOB 232 may be an edge emitting MOB. In various embodiments, the signal manipulation elements 236 include one or more of lenses, metasurfaces, diffractive optical elements, gratings, waveplates, or refractive optical elements. For example, a respective signal manipulation element 236 may be one of lens, a metasurface, a diffractive optical element, a grating, a waveplate, or a refractive optical element, or a combination of two or more thereof (e.g., a lens having a metasurface formed thereon, a waveplate followed by a lens, a grating followed by a metasurface, and/or the like).

In various embodiments, the signal manipulation elements 236 are configured to provide optical beams 5 (e.g., 5A, 5B) directly to respective target locations 122 (e.g., 122A, 122B). In other words, between the signal manipulation element 236 and the respective target location 122, an optical beam 5 propagates through free space (e.g., vacuum) and does not interact with any other optical elements between the signal manipulation element 236 and the respective target location 122. For example, no relay optics or assemblies are used to relay the optical beam between the signal manipulation element 236 and the respective target location 122.

In various embodiments, the distance D (e.g., the distance the optical beam propagates across) between the signal manipulation element 236 and the respective target location 122 is ten centimeters or less. For example, the distance D may be in a range of one micron to ten centimeters. In various embodiments, the plurality of signal manipulation elements 236 may extend into and/or out of the page in one-dimensional arrays of signal manipulation elements, for example. The distance D is configured such that optical beams provided by adjacent signal manipulation elements do not overlap such that the target locations 122 can be individually addressed, in various embodiments. For example, the distance D may be configured to suppress and/or reduce optical cross-talk between neighboring target locations 122.

In particular, the distance D is configured such that the optical beams that are spatially distinct at the target locations remain spatially distinct at the surface (e.g., face 237 or facet 235) of the MOB 232. In various embodiments, the maximum possible value for the distance D is defined by the spacing between the target locations 122 of the array of target locations 125 (e.g., the spacing between the optical beams when the optical beams are incident at the target locations 122), and the wavelength(s) that characterizes the optical beams and the desired size(s) of the optical mode(s) at the target locations, which defines how quickly the optical beams diverge/converge between the MOB and the target locations. Thus, in various embodiments, the distance D is configured such that none of the optical beams spatially overlap with any other of the optical beams as the optical beams propagate from the signal manipulation elements 236 to the respective target locations 122. In some embodiments, a MOB may be configured to provide multiple optical beams to the same target location. In such embodiments, the optical beams being provided to the same target location spatially overlap at the target location 122.

In various embodiments, the signal manipulation elements 236 are configured to control the respective directions of propagation of optical beams provided via the signal manipulation elements 236. For example, the signal manipulation elements 236 may control a direction of propagation of the optical beam 5 such that the optical beam 5 propagates from the signal manipulation element 236 toward the respective target location 122. In various embodiments the signal manipulation elements 236 may control various other optical properties of the optical beams 5 provided to the array of target locations 125. For example, a signal manipulation element 236 may be configured to control one or more of the focal point, polarization, wavelength/frequency, relative phase delay, optical mode, intensity, and/or other optical property of the optical beam 5 provided to the respective target location 122 via the signal manipulation element 236.

In various embodiments, the optical beam 5 propagates from the signal manipulation element 236 toward the respective target location 122 such that the direction of propagation of the optical beam 5 forms an angle θ with a plane that is parallel to the surface 126 of the atomic and/or quantum object confinement apparatus 120, as shown in FIG. 2A. In various embodiments, the angle θ is in a range of 0 to 45 degrees. In certain embodiments, the angle θ is in a range of 0 to 30 degrees. In certain embodiments, the angle θ is in a range of 0 to 20 degrees. In an example embodiment, the angle θ is ten degrees or smaller. For example, the optical beam 5 may be provided substantially parallel to the surface 126 of the atomic and/or quantum object confinement apparatus 120 and/or at a shallow angle with respect to the surface 126 of the atomic and/or quantum object confinement apparatus 120.

By providing the optical beams such that the optical beams propagate substantially parallel to and/or at a shallow angle with respect to the surface 126 of the atomic and/or quantum object confinement apparatus 120, reflection or scattering of optical beams off the surface 126 of the atomic and/or quantum object confinement apparatus 120may be avoided. For example, the optical beams may not be incident on the surface 126 at all or, if they are incident on the surface 126, the optical beams are incident on the surface 126 at a location that is not near any of the target locations of the atomic and/or quantum object confinement apparatus 120. This results in the atomic and/or quantum objects being less likely to interact with the reflected or scattered optical beams. Optical beams reflected or scattered off the surface 126 of the atomic and/or quantum object confinement apparatus 120 may result in cross-talk errors and/or other random memory errors that are difficult to account for and/or correct. Therefore, various embodiments reduce the occurrence of such errors.

Also, because the optical beams propagate substantially parallel to and/or at a shallow angle with respect to the surface 126 of the atomic and/or quantum object confinement apparatus 120 such that the optical beams may not be incident on the surface 126 at all or, if they are incident on the surface 126, are incident on the surface 126 at a location that is not near any of the target locations of the atomic and/or quantum object confinement apparatus 120, the possibility that the atomic and/or quantum objects will interact with stray electric fields generated by photoinduced electric static charge on the atomic and/or quantum object confinement apparatus is also reduced.

In various embodiments, the substrate 234 comprises one or more waveguides 238 formed therein. For example, the waveguides 238 may be formed via laser writing. For example, the substrate 234 may be a glass substrate that, via laser writing, has had waveguides 238 formed and/or defined therein. In various embodiments, the waveguides 238 are configured to direct and/or guide optical beams received by the MOB 232 to respective signal manipulation elements 236.

In various embodiments, the MOB 232 comprises one or more optical fiber coupling components 260. For example, the one or more optical fiber coupling components 260 may be a groove array (e.g., a V-groove array) formed in the substrate 234, a ferrule, an alignment assembly such as that disclosed in U.S. application Ser. No. 18/193,960, filed Mar. 31, 2023, the content of which is incorporated herein by reference in its entirety, and/or the like. In various embodiments, an optical fiber coupling component 260 is configured to mechanically secure an optical fiber 266 with respect to the substrate 234 and to optically couple the optical fiber 266 with a respective waveguide 238 formed and/or defined within the substrate 234. For example, optical fiber 266A is mechanically secured with respect to the substrate 234 via the optical fiber coupling component 260A and is optically coupled to the waveguide 238A via the optical fiber coupling component 260A.

In various embodiments, the waveguides 238 and signal manipulation elements 236 define beam paths through the MOB 232. For example, an optical beam is coupled into a beam path (e.g., coupled into a waveguide 238 via an optical fiber coupling component, for example), is guided along the beam path to a signal manipulation element 236. The signal manipulation element 236 controls one or more optical properties of the optical beam and, in some embodiments, releases the guided mode of the optical beam such that the optical beam propagates through free space to the respective target location 122. For example, optical path 240, shown in FIG. 2B, comprises any optical components of the optical fiber coupling component 260A configured to optically couple an optical fiber to waveguide 238A, the waveguide 238A, and the signal manipulation element 236A.

FIG. 2C illustrates an example embodiment in which optical beams are directed out of the waveguides 238 and toward the signal manipulation elements 236 using grating couplers 239 (e.g., 239A, 239B). For example, the grating coupler 239 may couple an optical beam guided mode propagating through the waveguide 238 into free space such that the optical beam propagates toward the signal manipulation element 236. The signal manipulation element 236 may then control one or more optical properties of the optical beam and cause the optical beam to be provided to a target location 122 of the array of target locations 125.

In certain embodiments, each beam path is configured and/or optimized for providing optical beams characterized by a respective wavelength. For example, each beam path is configured and/or optimized for providing optical beams of the same nominal wavelength. In other words, none of the beam paths of the optical beam delivery system 130 are configured to provide an IR optical beam and a visible optical beam, an IR optical beam and a UV optical beam, or a visible optical beam and a UV optical beam. This enables any optical coupling components of the optical fiber coupling component 260 configured to optically couple an optical fiber to a waveguide 238and the signal manipulation element 236 in optical communication with the waveguide 238 can be configured to efficiently interact with optical beams of a narrow wavelength range.

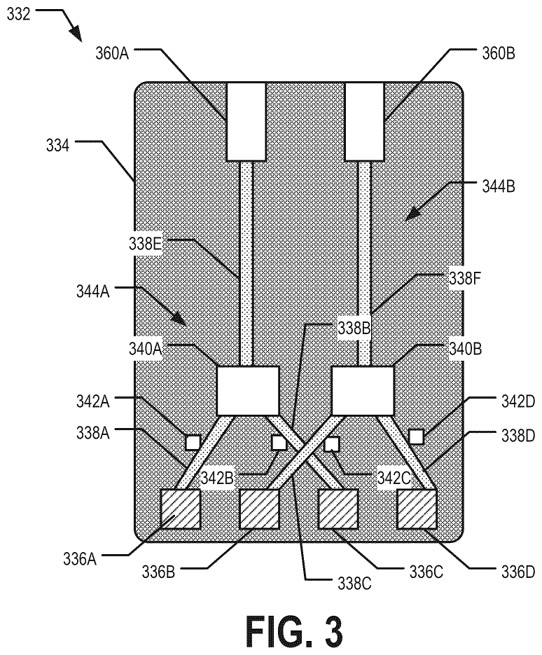

As shown in FIG. 3, sometimes the beam paths defined through the substrate are branched beam paths. FIG. 3 provides at least a partial cross-sectional view of an example MOB 332 comprising a substrate 334. Waveguides 338A-338F are formed and/or defined in the substrate 334. For example, the waveguides 338A-338F may be formed via laser writing a glass substrate 334, in certain embodiments. Signal manipulation elements 336A-336D are formed and/or secured on and/or in the substrate 334. From the perspective shown in FIG. 3, waveguides 338B and 338C appear to overlap or intersect. However, the waveguides may be formed and/or defined in three-dimensions such that waveguides 338B and 338C do not actually overlap or intersect and are independent waveguides. For example, the MOB 332 is configured for three-dimensional optical beam routing.

An optical fiber coupling component 360A, or other optical coupling component, couples a first optical beam into a waveguide 338E. A beam splitter 340A splits the first optical beam into two or more portions of the first optical beam and provides respective portions of the first optical beam to waveguides 338A and 338B. A first set of branched beam paths 344A includes any optical components of optical fiber coupling component 360A configured to couple optical beams into waveguide 338E, waveguide 338E, the beam splitter 340A, waveguides 338A, 338B, and signal manipulation elements 336A, 336C. Each of the components or elements of the first set of branched beam paths 344A are configured for interaction with optical beams of a first nominal wavelength. The first optical beam is characterized by the first nominal wavelength.

An optical fiber coupling component 360B, or other optical coupling component, couples a second optical beam into a waveguide 338F. A beam splitter 340B splits the second optical beam and provides respective portions of the second optical beam to waveguides 338C and 338D. A second set of branched beam paths 344B includes any optical components of optical fiber coupling component 360B configured to couple optical beams into waveguide 338F, waveguide 338F, the beam splitter 340B, waveguides 338C, 338D, and signal manipulation elements 336B, 336D. Each of the components or elements of the second set of branched beam paths 344B are configured for interaction with optical beams of a second nominal wavelength. The second optical beam is characterized by the second nominal wavelength. The second nominal wavelength may be the same or different from the first nominal wavelength.

In an example embodiment, signal manipulation elements 336A and 336B are configured to provide respective optical beams to the same target location. Thus, optical beams of various nominal wavelengths may be provided to a target location and each beam path (and/or set of branched beam paths) may be configured and/or optimized for use with a respective nominal wavelength and/or wavelength range.

In various embodiments, one or more waveguides 338 (e.g., 338A-338F) are coupled to respective modulators 342 (e.g., 342A-342D). For example, modulator 342A is configured to modulate the optical beam provided to waveguide 338A, modulator 342B is configured to modulate the optical beam provided to waveguide 338B, modulator 342C is configured to modulate the optical beam provided to waveguide 338C, and modulator 342D is configured to modulate the optical beam provided to waveguide 338D.

In various embodiments, a modulator 342 may be configured to act as a switch to either enable provision of an optical beam via a particular beam path or to prevent provision of the optical beam via the particular beam path. For example, when an optical beam is provided to the waveguide 338E, it may be desired to provide the optical beam to a target location corresponding to signal manipulation element 336A (but not to a target location corresponding to signal manipulation element 336C), a target location corresponding to signal manipulation element 336C (but not to a target location corresponding to signal manipulation element 336A), target locations corresponding to signal manipulation elements 336A, 336C, respectively, or to neither of the target locations corresponding to signal manipulation elements 336A, 336C. In another example, when an optical beam is provided to the waveguide 338F, it may be desired to provide the optical beam to a target location corresponding to signal manipulation element 336B (but not to a target location corresponding to signal manipulation element 336D), a target location corresponding to signal manipulation element 336D (but not to a target location corresponding to signal manipulation element 336B), target locations corresponding to signal manipulation elements 336B, 336D, respectively, or to neither of the target locations corresponding to signal manipulation elements 336B, 336D. The modulators 342 (e.g., 342A-342D) enables individual control over which beam paths of a set of branched beam paths provide the optical beam at a particular point in time. This enables steady state operation of a manipulation source 60 configured to generate the first optical signal.

In various embodiments, the operation of the modulators 342 may be controlled by the controller 30. For example, a modulator 342 may be configured to receive an electrical or optical input signal that operation of the modulator 342 to either provide or not provide a respective optical beam along a respective optical path. The controller 30 (e.g., a driver controller element 515, see FIG. 5, of the controller 30) may be configured to generate or control generation of the electrical or optical input signal.

As used herein a set of branched beam paths is a set of beam paths that are optically connected to one another via one or more beam splitters. For example, each beam path of a set of branched beam paths is optically coupled to a common optical beam input and/or configured to receive a respective portion of a common optical beam. While FIG. 3 illustrates sets of branched beam paths 344A, 344B, that each include two beam paths, a set of branched beam paths may include any number of beam paths (e.g., two or more).

Each signal manipulation element 236, 336 is associated with one beam path. For example, the signal manipulation elements 236, 336 are non-global optical elements. For example, as each beam path is configured and/or optimized for use with optical beams characterized by a respective wavelength, the signal manipulation element of a beam path may be configured and/or optimized for use with optical beams characterized by the respective wavelength.

In some embodiments, as shown in FIG. 2A, one or more surfaces of the substrate 234 may have a coating 250 applied thereto. In various embodiments, the coating 250 is an electrically conductive coating. For example, the coating 250 may be electrically conductive and grounded (e.g., in electrical communication with local electrical ground) in order to prevent buildup of electrical charge on the surface of the MOB 232. For example, buildup of electrical charge on the surface of the MOB 232 may generate electrical fields that may have an undesired and/or negative effects on atomic and/or quantum objects confined by the atomic and/or quantum object confinement apparatus 120. By grounding the coating 250, the buildup of electrical charge on the coated surface(s) of the MOB 232 is prevented. In various embodiments, openings 255 are formed in the coating 250 to enable optical beams 5 to exit the MOB 232. For example, openings 255 may be formed through coating 250 to optically align with the signal manipulation elements 236.

In some embodiments, the coating 250 may be used to spatially filter the optical beams provided to respective target locations 122. For example, light leaked out of a waveguide 238 within the substrate 234 that is incident on a surface of the substrate 234 that is coated with coating 250 will be blocked from exiting the substrate 234. For example, the leaked light may be absorbed by the coating 250. In other words, the leaked light is, generally, prevented from being incident on target locations (and interacting with any atomic and/or quantum objects confined at the target locations) by the coating 250.

In various embodiments, the MOB(s) of an optical beam delivery system are disposed within a cryogenic and/or vacuum chamber. In various embodiments, the MOB(s) of the optical beam delivery system are configured for use under vacuum conditions. For example, the MOB(s) of the optical beam delivery system may be configured for use at pressures less than 10⁻⁶ mbar. For example, the MOB(s) of the optical beam delivery system may be configured for use under ultra-high vacuum (UHV) conditions (e.g., pressures in a range of 10⁻⁶ to 10⁻⁹ mbar) and/or under extreme high vacuum (XHV) conditions (e.g., pressures in a range of 10⁻⁹ to 10⁻¹² mbar or pressures less than 10⁻⁹ mbar). For example, in various embodiments, the MOB(s) comprises and/or consists of materials configured to not substantially off-gas when under UHV and/or XHV conditions.

In various embodiments, the MOB(s) of the optical beam delivery system are configured for use under cryogenic conditions. As used herein cryogenic conditions are temperatures less than 124 K. In various embodiments, the optical beam delivery system is configured for use at a working temperature where the working temperature is a cryogenic temperature (e.g., 124 K or less). In some embodiments, the working temperature is 100 K or less. For example, a MOB of the optical beam delivery system may be fabricated at a temperature that is not the working temperature (e.g., at a non-cryogenic temperature that is greater than 124 K). In various embodiments, the waveguides and/or signal manipulation elements of a MOB are configured and/or designed such that the desired optical effects are achieved at the working temperature. For example, the thermal contraction of the substrate, material of the signal manipulation elements, and/or the like is taken into consideration when determining the fabrication specification of the MOB(s) of the optical beam delivery system. For example, when optical beams are provided to the optical inputs of a MOB (e.g., optical fiber coupling components 260, 360) the waveguides 238, 338 and the signal manipulation elements 236, 336 are configured to provide optical beams such that the optical beams are incident at respective target locations 122 of an array of target locations 125 when the MOB is at the working temperature (e.g., less than 124 K).

However, when optical beams are provided to the optical inputs of the of the MOB when the MOB is at a non-cryogenic temperature (e.g., greater than 124 K), the output optical beams (e.g., optical beam provided via the signal manipulation elements 236, 336) do not correspond to the spacing of the array of target locations 125. For example, when optical beams are provided to the MOB 332 when the MOB 332 is at the working temperature, MOB 332 is configured such that the first optical signal provided by the first signal manipulation element 336A and the second optical signal provided by the second signal manipulation element 336B are provided to a first target location and the first optical signal provided by the third signal manipulation element 336C and the second optical signal provided by the fourth signal manipulation element 336D are provided to a second target location. However, when optical beams are provided to the MOB 332 at a non-cryogenic temperature, the optical beams provided by the first signal manipulation element 336A and the second signal manipulation element 336B may not intersect at a location that corresponds to the first target location (e.g., based on the distance D between the respective manipulation elements and the target location) and the optical beams provided by the third signal manipulation element 336C and the fourth signal manipulation element 336D may not intersect at a location that corresponds to the second target location. In other words, the first optical beam provided by the first signal manipulation element 336A and the second optical beam provided by the second signal manipulation element 336B may not overlap at the appropriate distances D from the respective signal manipulation elements. Moreover, the spacing between the locations where the first optical beam provided by the first signal manipulation element 336A and the second optical beam provided by the second signal manipulation element 336B intersect and where the first optical beam provided by the third signal manipulation element 336C and the second optical beam provided by the fourth signal manipulation element 336D overlap may not correspond to the spacing of the array of target locations 125. For example, provision of optical beams to the optical beam delivery system when the one or more MOBs are at a non-cryogenic temperature, results in providing an array of optical beams that is characterized by a different spacing than the array of target locations.

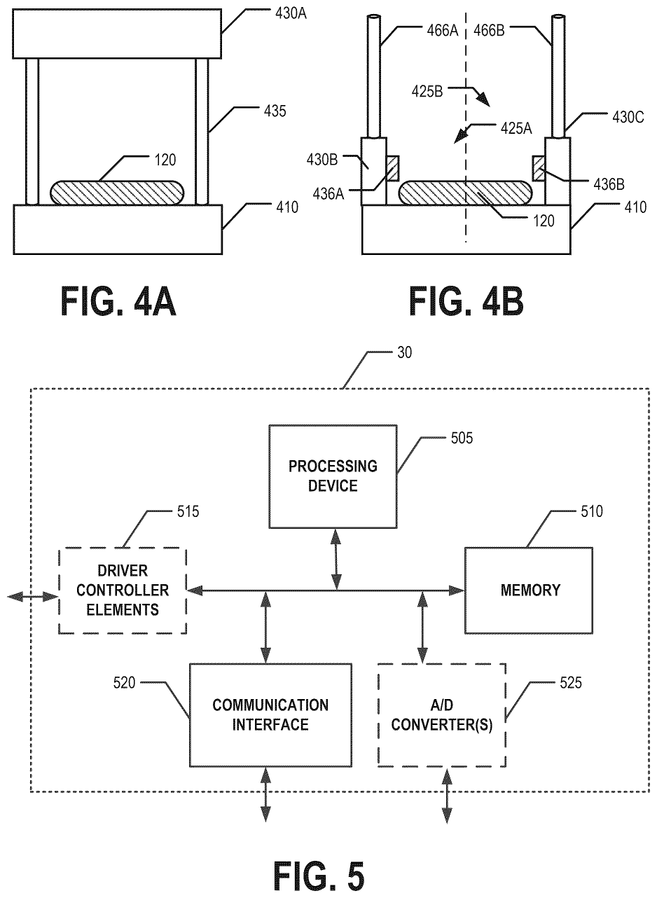

In various embodiments, each MOB of the optical beam delivery system is mounted within a cryogenic and/or vacuum chamber 40. For example, the cryogenic and/or vacuum chamber 40 may house an atomic and/or quantum object confinement apparatus 120 that defines an array of target locations 125. For example, the MOB(s) of the optical beam delivery system may be mounted into a fixed relationship with the target locations 122. In some embodiments, a MOB 132 may be mounted to an interior of the cryogenic and/or vacuum chamber 40 via mounting components 135. FIG. 4A illustrates an example embodiment where a MOB 430A is mounted to a pedestal 410 configured to host the atomic and/or quantum object confinement apparatus 120 via mounting components 435. In some embodiments, a MOB is mounted to atomic and/or quantum object confinement apparatus 120 and/or another MOB via mounted components.

In various embodiments, the mounting components 135, 435 are spacers. For example, the mounting components 135, 435 are portions of a wafer and/or other precisely sized spacer elements. In some embodiments, the mounting components 135, 435 are part of a dynamic stage comprising nano-positioners. For example, the mounting components 135, 435 may be or include mechanical positioners such that the relative position of the MOB 430A with respect to the atomic and/or quantum object confinement apparatus 120 may be adjusted. For example, the mechanical positioners may enable active alignment of the MOB 430A with an array of target locations. In some embodiments, the mechanical positioners are nano-positioners configured to provide nanometer scale precision in positioning of the MOB 430A (e.g., relative to the array of target locations and/or the atomic and/or quantum object confinement apparatus 120). For example, the mechanical positioners may be piezoelectric nano-positioners and/or other nano-positioners.

FIG. 4B illustrates an example embodiment where multiple MOBs 430B, 430C are mounted to a pedestal 410 configured to host the atomic and/or quantum object confinement apparatus 120 such that the MOBs 430B, 430C extend substantially perpendicular to the surface of the atomic and/or quantum object confinement apparatus 120. In other embodiments, the MOBs 430B, 430C may be mounted to the atomic and/or quantum object confinement apparatus 120, an interior of the cryostat and/or vacuum chamber 40, and/or other structure within the cryostat and/or vacuum chamber such that the MOBs 430B, 430C extend substantially perpendicular to the surface of the atomic and/or quantum object confinement apparatus 120. While not shown in FIG. 4B, the MOBs 430B, 430C may be mounted to the pedestal 410, atomic and/or quantum object confinement apparatus 120, interior of the cryostat and/or vacuum chamber, or another structure within the cryostat and/or vacuum chamber using a mechanical positioner such as a nano-positioner.

As shown in FIG. 4B, a MOB may be configured to provide optical beams to a subset of target locations of the array of target locations. For example, optical fiber 466A provides a first optical beam to MOB 430B. The first optical beam is then provided to one or more target locations of a first portion 425A of the array of target locations via an array of signal manipulation elements 436A of the MOB 430B. The optical fiber 466B provides a second optical beam to MOB 430C. The second optical beam is then provided to one or more target locations of a second portion 425B of the array of target locations via an array of signal manipulation elements 436B of the MOB 430C. For example, a plurality of MOBs may be configured to each provide optical beams to respective subsets of target locations of the array of target locations where the respective subsets of target locations are each defined by a respective portion of the atomic and/or quantum object confinement apparatus 120.

### Technical Advantages

In various systems, it is desired to provide an array of optical beams to an array of target locations. For example, in atomic and/or quantum systems, the optical beams may be used to interact with atomic and/or quantum objects confined at the target locations that are disposed within a vacuum chamber and/or cryostat. Conventionally, the optical beams are provided via an optical beam delivery system located outside of the vacuum chamber and/or cryostat using global relay optics. However, in such an approach, the global relay optics are required to be designed for use with a broad range of optical wavelengths (e.g., infrared (IR) through ultraviolet (UV)). As a result, the global relay optics may not be able efficiently provide at least a subset of the optical beams. Additionally, when the MOB is far from the array of target locations, the arrayed optical beams overlap and individual target locations may no longer be addressed individually. Therefore technical problems exist regarding providing an array of optical beams to an array of target locations, especially when the array of target locations are located within a cryogenic and/or vacuum chamber.

Various embodiments provide technical solutions to these technical problems. In various embodiments, an optical beam delivery system is provided that includes one or more micro-optical benches (MOBs) configured to be mounted within a cryogenic and/or vacuum chamber that houses an atomic and/or quantum object confinement apparatus. The atomic and/or quantum object confinement apparatus defines a plurality of target locations. In various embodiments, the plurality of target locations are arranged in a one-dimensional or two-dimensional periodic array of target locations. Mounting the MOBs within the cryogenic and/or vacuum chamber enables the MOBs to be within 10 centimeters of the target locations. Thus, no global relay optics are required. In other words, the MOBs provide the optical beams directly to the target locations. As used herein providing an optical beam directly to a target location via a MOB means that there are no optical elements between the point where the optical beam exits the MOB and the target location. For example, between the MOB and the target location, an optical beam may propagate (only) through free space (e.g., through (only) vacuum since the MOB and the target location are located within a cryogenic and/or vacuum chamber). As a result, no global relay optics are required. For example, each beam path of the optical beam delivery system may be designed, configured, and/or optimized for providing optical beams of a particular characteristic wavelength. This enables the system to provide optical beams more efficiently such that less optical power is lost as the optical beams are provided to the plurality of target locations. Additionally, as optical beams are provided by MOBs no more than 10 centimeters from the respective target locations, the array of optical beams may be configured to not spatially overlap such that individual target locations may be addressed individually (e.g., independently of other target locations). Therefore, various embodiments provide technical improvements and/or advantages to the fields of optical beam delivery, optical beam delivery of an array of optical beams characterized by various wavelengths across the optical spectrum (e.g., IR to UV), and/or optical beam delivery to target locations of atomic and/or quantum systems disposed within a cryogenic and/or vacuum chamber.

### Exemplary Controller

In various embodiments, a quantum computer 110 comprises a controller 30 configured to control various elements of the quantum computer 110. In various embodiments, a controller 30 may be configured to cause a quantum computer 110 to perform various operations (e.g., computing operations such as gate operations, cooling operations, atomic and/or quantum object transport operations, qubit interaction operations (e.g., two-qubit gates), qubit measurement operations, leakage suppression operations, and/or the like). For example, the controller 30 may be configured to cause manipulation sources 60 to provide manipulation signals (e.g., optical beams) to atomic and/or quantum objects (e.g., atoms, ions, molecules, quantum particles, and/or the like) confined and/or trapped within the confinement apparatus 120. For example, the controller 30 may be configured to cause the manipulation sources 60 to provide one or more laser and/or optical beams and/or pulses to one or more target locations 122 defined at least in part by the confinement apparatus 120 so as to enact, for example, one or more quantum gates, read a quantum state of an atomic and/or quantum object, perform sympathetic laser cooling of an atomic and/or quantum object, and/or the like. In various embodiments, the controller 30 may be configured to control a cryogenic system and/or vacuum system controlling the temperature and pressure within the cryogenic and/or vacuum chamber 40, manipulation sources 60, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more atomic and/or quantum objects confined by the confinement apparatus 120.

As shown in FIG. 5, in various embodiments, the controller 30 may comprise various controller elements including processing element(s) 505, memory 510, driver controller elements 515, a communication interface 520, analog-digital converter 525, and/or the like. For example, the processing element(s) 505 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products. In an example embodiment, the processing element(s) 505 of the controller 30 comprises a clock and/or is in communication with a clock.

For example, the memory 510 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 510 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 510 (e.g., by a processing element(s) 505) causes the controller 30 to perform one or more steps, operations, processes, procedures and/or the like described herein for tracking the phase of an atomic object within an atomic system and causing the adjustment of the phase of one or more manipulation sources and/or signal(s) generated thereby.

In various embodiments, the driver controller elements 515 may include one or more drivers and/or controller elements each configured to control one or more drivers. In various embodiments, the driver controller elements 515 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element(s) 505). In various embodiments, the driver controller elements 515 may enable the controller 30 to operate voltage sources 50, manipulation sources 60 (e.g., laser systems), vacuum and/or cryogenic systems, and/or the like. In various embodiments, the drivers may be laser drivers; microwave drivers; vacuum component drivers; cryogenic and/or vacuum system component drivers; current drivers, and/or the like. For example, the drivers and/or driver controllers may be configured to cause a magnetic field generation device (e.g., comprising circuitry coupled to a voltage source (e.g., a current driver or voltage driver), permanent magnet(s), and/or a combination thereof) to generate a magnetic field having a particular direction and magnitude at one or more regions of and/or locations defined at least in part by the confinement apparatus 120. In various embodiments, a plurality of target locations 122 and/or an array of target locations 125 are defined at least in part by the confinement apparatus 120.

In various embodiments, the controller 30 comprises means for communicating and/or receiving signals from one or more sensors and/or optical receiver components such as cameras, MEMs cameras, CCD cameras, photodiodes, photomultiplier tubes, and/or the like. For example, the controller 30 may comprise one or more analog-digital converter element(s) 525 configured to receive signals from one or more optical receiver components, calibration sensors, and/or the like.

In various embodiments, the controller 30 may comprise a communication interface 520 for interfacing and/or communicating with a computing entity 10. For example, the controller 30 may comprise a communication interface 520 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Example Computing Entity

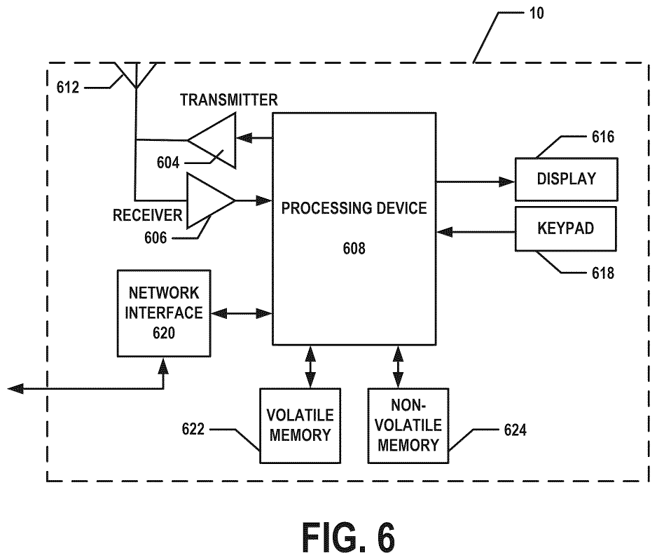

FIG. 6 provides an illustrative schematic diagram of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110. For example, a user may operate a computing entity 10 to generate and/or program a quantum algorithm and/or quantum circuit that may be provided such that the controller 30 may receive the quantum algorithm and/or quantum circuit and cause the quantum computer 110 to perform the quantum algorithm and/or quantum circuit.

As shown in FIG. 6, a computing entity 10 can include an antenna 612, a transmitter 604 (e.g., radio), a receiver 606 (e.g., radio), and a processing element 608 that provides signals to and receives signals from the transmitter 604 and receiver 606, respectively, which may collectively be referred to a transceiver. The signals provided to and received from the transmitter 604 and the receiver 606, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 includes one or more network interfaces 620 configured to communicate (e.g., with the controller 30 and/or one or more other computing entities 10) via one or more wired and/or wireless networks 20.

The computing entity 10 may also comprise a user interface device comprising one or more user input/output interfaces (e.g., a display 616 and/or speaker/speaker driver coupled to a processing element(s) 608 and a touch screen, keyboard, mouse, and/or microphone coupled to a processing element(s) 608). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 618 (hard or soft), a touch display, voice/speech or motion interfaces, scanners, readers, or other input device. In embodiments including a keypad 618, the keypad 618 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile memory or storage 622 and/or non-volatile memory or storage 624, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An optical beam delivery system comprising:
one or more micro-optical benches (MOBs), wherein each MOB of the one or more MOBs comprises:
a substrate, and
a plurality of signal manipulation elements, each signal manipulation element of the plurality of signal manipulation elements disposed on or in the substrate,
wherein the plurality of signal manipulation elements are configured to provide an array of optical beams directly to an array of target locations such that optical beams provided to different target locations of the array of target locations do not spatially overlap between respective signal manipulation elements of the plurality of signal manipulation elements and respective target locations.

2. The optical beam delivery system of claim 1, wherein each signal manipulation element is a non-global optical element and is part of a single optical path of the MOB.

3. The optical beam delivery system of claim 1, wherein each signal manipulation element comprises at least one of a lens, a metasurface, a diffractive optical element, a grating, a waveplate, or a refractive optical element.

4. The optical beam delivery system of claim 1, wherein the optical beam delivery system is configured for use at a working temperature and the working temperature is 100K or less.

5. The optical beam delivery system of claim 4, wherein the optical beam delivery system is configured such that provision of optical beams to the optical beam delivery system when the one or more MOBs are at the working temperature, results in providing the array of optical beams characterized by an optical beam spacing corresponding to a spacing of the array of target locations and provision of optical beams to the optical beam delivery system when the one or more MOBs are at a non-cryogenic temperature, results in providing the array of optical beams characterized by a different spacing than the array of target locations.

6. The optical beam delivery system of claim 1, wherein each MOB is configured to be disposed within 10 centimeters of the respective array of target locations.

7. The optical beam delivery system of claim 1, wherein each MOB further comprises one or more waveguides formed in the respective substrate.

8. The optical beam delivery system of claim 7, wherein the one or more waveguides and the plurality of signal manipulation elements define a plurality of beam paths with each beam path of the plurality of beam paths configured for providing optical beams characterized by a respective wavelength to a respective target location of the array of target locations.

9. The optical beam delivery system of claim 8, wherein the substrate further comprises one or more optical fiber coupling components, each of the one or more optical fiber coupling components configured for mechanically coupling an optical fiber to the substrate and to optically couple the optical fiber to one or more beam paths of the plurality of beam paths.

10. The optical beam delivery system of claim 9, wherein the one or more beam paths form sets of branched beam paths where two or more beam paths of a set of branched beam paths are connected to one another via one or more beam splitters.

11. The optical beam delivery system of claim 9, wherein the optical fiber provides optical beams having a respective common characteristic wavelength.

12. The optical beam delivery system of claim 8, wherein at least one beam path of the plurality of beam paths comprises a modulator configured to control, at least in part, whether an optical beam is provided to the respective target location via the beam path when the optical beam is provided to the beam path.

13. The optical beam delivery system of claim 8, wherein the beam path comprises a respective one or more signal manipulation elements of the plurality of signal manipulation elements and the respective one or more signal manipulation elements of the beam path are configured to control one or more optical properties of an optical beam provided to a corresponding target location via the beam path.

14. An atomic or quantum system comprising:
a vacuum chamber;
an atomic or quantum object confinement apparatus disposed within the vacuum chamber and defining an array of target locations; and
an optical beam delivery system comprising:
one or more micro-optical benches (MOBs), wherein each MOB of the one or more MOBs comprises:
a substrate, and
a plurality of signal manipulation elements, each signal manipulation element of the plurality of signal manipulation elements disposed on or in the substrate,
wherein the plurality of signal manipulation elements are configured to provide an array of optical beams directly to the array of target locations,
wherein the one or more MOBs are disposed within the vacuum chamber.

15. The system of claim 14, further comprising one or more lasers coupled to the one or more MOBs via respective optical fibers such that the one or more lasers are configured to provide optical beams to the one or more MOBs via the respective optical fibers and the one or more lasers disposed outside of the vacuum chamber.

16. The system of claim 14, wherein the one or more MOBs are mounted to at least one of an interior surface of the vacuum chamber, a pedestal configured to host the atomic or quantum object confinement apparatus, or the atomic or quantum object confinement apparatus.

17. The system of claim 14, wherein the one or more MOBs are mounted within the vacuum chamber via dynamic stages comprising mechanical positioners.

18. The system of claim 14, wherein the vacuum chamber is a cryogenic chamber and the optical beam delivery system is configured for use at a working temperature and the working temperature is 100K or less.

19. The system of claim 14, wherein the MOB is configured to be disposed within 10 centimeters of the array of target locations.

20. The system of claim 14, wherein the system is a QCCD-based quantum computer.
